(19) United States
(12) Patent Application Publication
(10) Pub. No.: US 2013/0170773 A1
(43) Pub. Date: Jul. 4, 2013

(54) ROLLER-TYPE LINEAR SLIDING BLOCK

(71) Applicant: Kuo-Le Tsao, New Taipei City (TW)

(72) Inventor: Kuo-Le Tsao, New Taipei City (TW)

(21) Appl. No.: 13/436,955

(22) Filed: Apr. 1, 2012

(30) Foreign Application Priority Data
Dec. 30, 2011 (TW) 100224996

(51) Int. Cl. F16C 29/06; F16C 33/66

(52) U.S. Cl. 384/13; 384/44

(57) ABSTRACT

A roller-type linear sliding block includes a base block, two circulation-guiding blocks coupled to two ends of the base block and rollers received in the base block. The base block has a sliding groove corresponding to a linear sliding rail and a pair of load-bearing tracks formed at two sides of the sliding groove. The base block is formed with a cover member. The cover member is formed with non-load tracks beside the load-bearing tracks and retainers at two sides of each load-bearing track. Each circulation-guiding block includes an inner circulation member formed with an end of the cover member, a middle spacer and an outer circulation member connected to the inner circulation member in series to form a first circulation track and a second circulation track in the circulation-guiding block. Through the first and second circulation tracks, the rollers run in the load-bearing tracks and the non-load tracks.

### CROSS REFERENCE TO RELATED APPLICATIONS

This application is based upon and claims the benefit of priority from the prior Taiwan Patent Application No. 100224996, filed on Dec. 30, 2011, the entire contents of which are incorporated herein by reference.

### BACKGROUND OF THE INVENTION

(a) Field of the Invention

The present invention relates to a roller-type linear sliding block, and more particularly to a linear sliding block mounted on a linear sliding rail through a plurality of rollers to carry an object for enabling the object to move along the linear sliding rail.

(b) Description of the Prior Art

A conventional linear sliding block has load-bearing tracks and non-load tracks for rolling balls to slide along a sliding rail. The load-bearing tracks and the non-load tracks are parallel. Both ends of the linear sliding block are provided with two circulation-guiding blocks to interconnect the load-bearing tracks and the non-load tracks, so that the linear sliding block can slide on the sliding rail through the rolling balls. When an apparatus needs great precision, load and rigidity, rollers are required instead of the rolling balls for the linear sliding block to have better rigidity and load capabilities.

However, the running of the rollers is subject to the configuration of the circulation-guiding block between the load-bearing tracks and the non-load tracks. The circulation tracks of the circulation-guiding block are interlaced and the oil passage of the circulation-guiding block must avoid the circulation tracks. This causes the configuration of the circulation-guiding block is complicated. For molding, plastic injection, assembly of parts, the manufacture procedures of the linear sliding block cannot be simplified so the cost cannot be lowered. Accordingly, the inventor of the present invention has devoted himself based on his many years of practical experiences to solve these problems.

### SUMMARY OF THE INVENTION

The primary object of the present invention is to provide a roller-type linear sliding block which comprises base block, two circulation-guiding blocks coupled to two opposing ends of the base block and a plurality of rollers received in the base block. The base block has a sliding groove corresponding to a linear sliding rail and a pair of load-bearing tracks formed at two sides of the sliding groove. The base block is formed with a cover member by molding. The cover member is formed with a pair of non-load tracks beside the pair of load-bearing tracks and a pair of retainers at two sides of each of the load-bearing tracks. Each of the circulation-guiding blocks comprises an inner circulation member which is integrally formed with an end of the cover member of the base block, a middle spacer coupled to the inner circulation member and an outer circulation member. The middle spacer and the outer circulation member are connected to an outer side of the inner circulation member in series. The inner circulation member cooperates with the middle spacer to form a first circulation track. The middle spacer cooperates with the outer circulation member to form a second circulation track. The first circulation track and the second circulation track are interlaced. Each circulation track of this configuration has a larger U-turn radius, so the rollers can run smoothly to decrease the noise when running. The linear sliding block is compact with great precision.

A further object of the present invention is to provide a roller-type linear sliding block, which has simple manufacture procedures and few parts for mass production so as to lower the cost.

### BRIEF DESCRIPTION OF THE DRAWINGS

FIG. 1 is a perspective view of the present invention;

FIG. 2 is an exploded view of the present invention;

FIG. 3 is a partial sectional view of the present invention;

FIG. 4 is a partial sectional view showing the base block of the present invention;

FIG. 5 is an exploded view showing the inner circulation member and the middle spacer of the present invention;

FIG. 6 is an exploded view showing the middle spacer and the outer circulation member of the present invention;

FIG. 7 is a partial sectional view showing circulation-guiding block of the present invention; and

FIG. 8 is an exploded view showing the outer circulation member and the oil scraper of the present invention.

### DETAILED DESCRIPTION OF THE PREFERRED EMBODIMENTS

Embodiments of the present invention will now be described, by way of example only, with reference to the accompanying drawings.

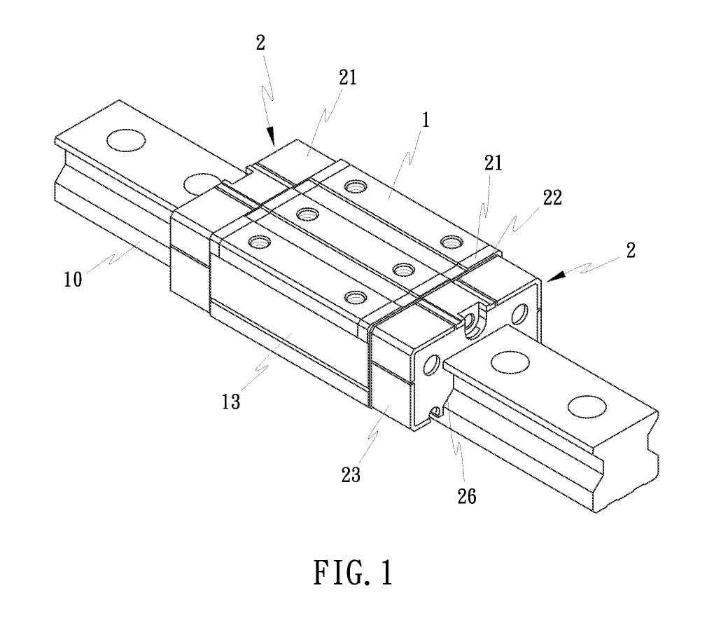

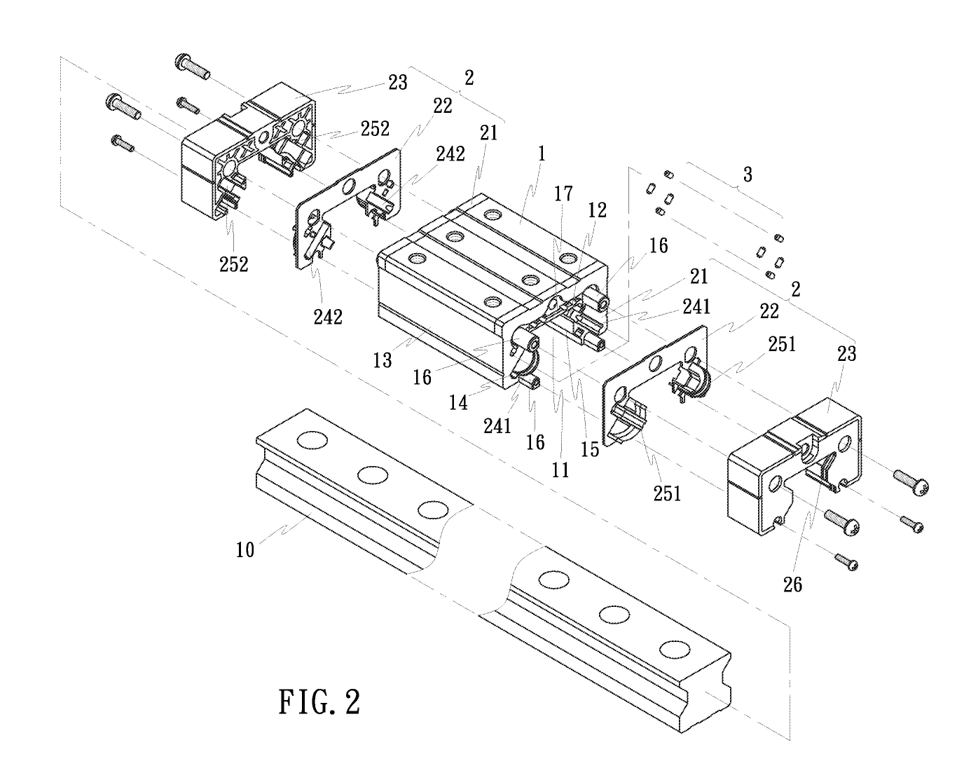

As shown in FIG. 1 and FIG. 2, the roller-type linear sliding block according to a preferred embodiment of the present invention comprises a base block 1, two circulation-guiding blocks 2 coupled to two opposing ends of the base block 1, and a plurality of rollers 3 received in the base block 1. The base block 1 has a sliding groove 11 corresponding to a linear sliding rail 10 and a pair of load-bearing tracks 12 formed at two sides of the sliding groove 11.

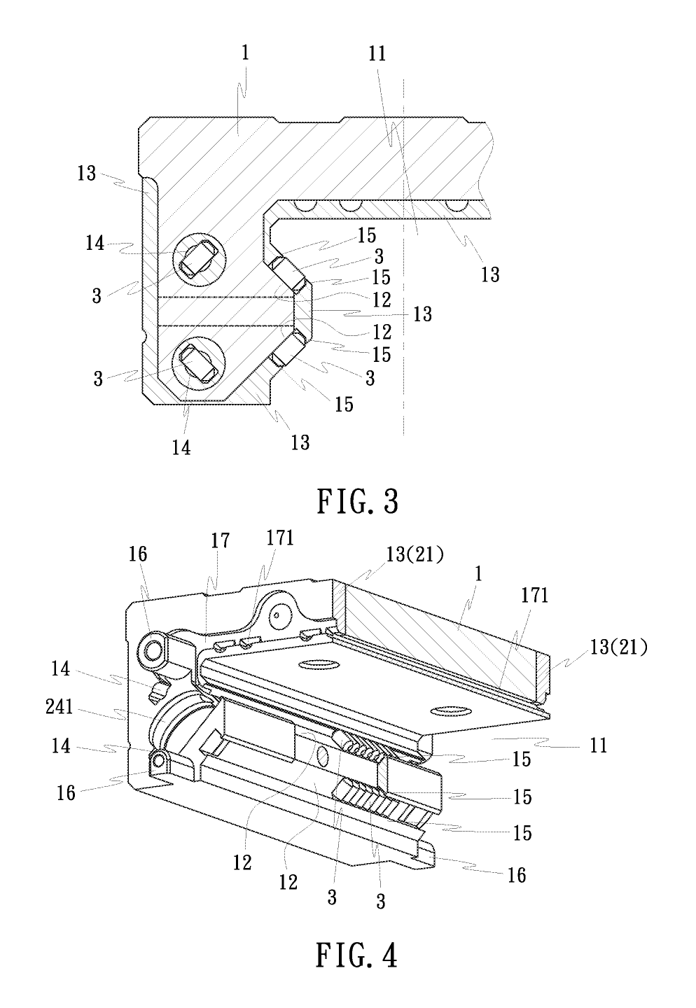

The surface of the base block 1 is formed with a cover member 13 by molding. The cover member 13 is formed with a pair of non-load tracks 14 beside the pair of load-bearing tracks 12 and a pair of retainers 15 at two sides of each of the load-bearing tracks 12, referring to FIG. 3 and FIG. 4.

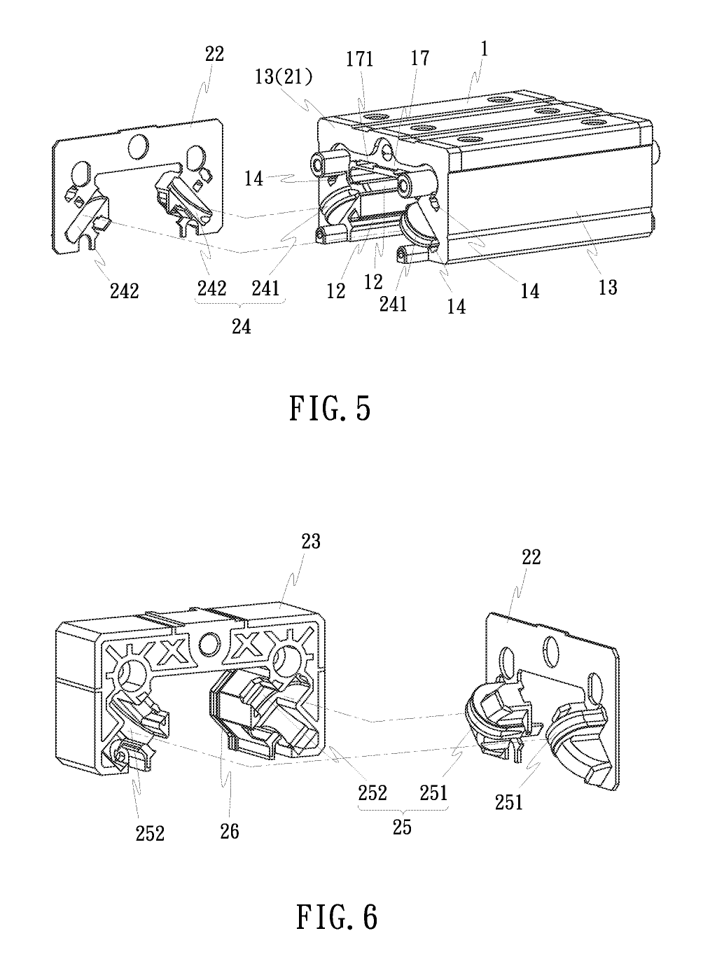

Each circulation-guiding block 2 comprises an inner circulation member 21 which is integrally formed with an end of the cover member 13 of the base block 1, a middle spacer 22, and an outer circulation member 23. The middle spacer 22 and the outer circulation member 23 are connected to the outer side of the inner circulation member 21 in series. The inner circulation member 21 cooperates with the middle spacer 22 to form a first circulation track 24, as shown in FIG. 5. The middle spacer 22 cooperates with the outer circulation member 23 to form a second circulation track 25, as shown in FIG. 6. The first circulation track 24 and the second circulation track 25 are interlaced.

According to the aforesaid configuration, through the circulation-guiding blocks 2 at the two ends of the base block 1, the rollers 3 pass through the first circulation track 24 and the second circulation track 25 to run in the load-bearing tracks 12 and the non-load tracks 14. The base block 1 is quickly formed with the non-load tracks 14 and the retainers 15 through the cover member 13 to increase the manufacture efficiency and to lower the manufacture cost.

As shown in FIG. 3 and FIG. 4, the retainers 15 at the two sides of each load-bearing track 12 are adapted to hold the rollers 3 in the load-bearing track 12 stably, so that the rollers 3 won't disengage from the load-bearing track 12. After the rollers 3 are filled in the roller-type sliding block of the present invention, there is no need for a provisional track or a chain-type retainer to position the rollers 3 in the load-bearing track 12 when the product is delivered or before the rail is assembled. In this way, the required parts are decreased to lower the cost effectively.

In the preferred embodiment of the present invention, the outer surface of the base block 1 is formed with the cover member 13. The end of the base block 1 is formed with the inner circulation member 21, and can be further formed with lock posts 16 and an oil passage 17 as shown in FIG. 2 and FIG. 4. The middle spacer 22 and the outer circulation member 23 are positioned by the lock posts 16, without an additional procedure to drill the base block 1. The oil passage 17 is disposed in the inner circulation member 21, which is beneficial to guide oil into the load-bearing tracks 12 and the non-load tracks 14. Preferably, each of the oil passages 17 disposed at the two ends of the base block 1 has at least a through hole 171 to communicate with the sliding trough 11 as shown in FIG. 4, so that the linear sliding block can be lubricated smoothly.

Furthermore, the circulation-guiding block 2 is composed of the inner circulation member 21, the middle spacer 22 and the outer circulation member 23. The inner circulation member 21 has an inner track groove 241. The middle spacer 22 has an outer track groove 242 at one side thereof facing the inner circulation member 21, as shown in FIG. 5. The inner track groove 241 of the inner circulation member 21 and the outer track groove 242 of the middle spacer 22 are to form the first circulation track 24. The middle spacer 22 has an inner track groove 251 at another side thereof facing the outer circulation member 23. The outer circulation member 23 has an outer track groove 252 at one side thereof facing the middle spacer 22, as shown in FIG. 6. The inner track groove 251 of the middle spacer 22 and the outer track groove 252 of the outer circulation member 23 are to form the second circulation track 25. The middle spacer 22 and the outer circulation member 23 are coupled to the outer end of the inner circulation member 21 in series. The inner track groove 241 and the outer track groove 242 are to form the U-shaped first circulation track 24. The inner track groove 251 and the outer track groove 252 are to form the U-shaped second circulation track 25. The two ends of the first circulation track 24 and the second circulation track 25 are respectively interconnected with the load-bearing tracks 12 and the non-load tracks 14 to constitute the U-turn route of the rollers 3. Each circulation track of this configuration has a larger U-turn radius, so that the rollers 3 can run smoothly to decrease the noise when running.

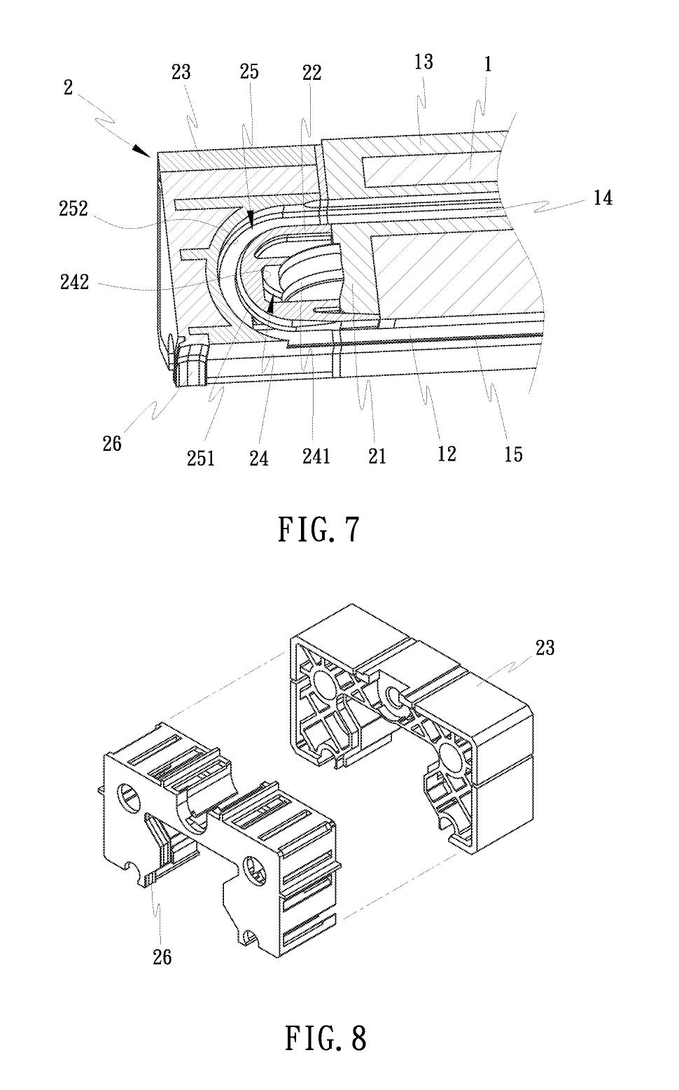

Furthermore, the outer circulation member 23 is formed with an oil scraper 26 corresponding to the linear sliding rail. The oil scraper 26 is secondarily molded on the outer circulation member 23, as shown in FIG. 7 and FIG. 8. The oil scraper 26 and the outer circulation member 23 are formed with the same mold by injection, so it is easy to control its contact size relative to the rail. The oil scraper 26 can mate with the rail exactly, not interfering with running of linear sliding block.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A roller-type linear sliding block, comprising a base block, two circulation-guiding blocks coupled to two opposing ends of the base block and a plurality of rollers received in the base block, the base block having a sliding groove corresponding to a linear sliding rail and a pair of load-bearing tracks formed at two sides of the sliding groove;
the base block being formed with a cover member by molding, the cover member being formed with a pair of non-load tracks beside the pair of load-bearing tracks and a pair of retainers at two sides of each of the load-bearing tracks;
each of the circulation-guiding blocks comprising an inner circulation member which is integrally formed with an end of the cover member of the base block, a middle spacer coupled to the inner circulation member and an outer circulation member, the middle spacer and the outer circulation member being connected to an outer side of the inner circulation member in series, the inner circulation member cooperating with the middle spacer to form a first circulation track, the middle spacer cooperating with the outer circulation member to form a second circulation track, the first circulation track and the second circulation track being interlaced.

2. The roller-type linear sliding block as claimed in claim 1, wherein two ends of the cover member of the base block are respectively formed with lock posts.

3. The roller-type linear sliding block as claimed in claim 2, wherein the two ends of the cover member of the base block are respectively formed with oil passages.

4. The roller-type linear sliding block as claimed in claim 3, wherein each of the oil passages has at least a through hole to communicate with the sliding trough.

5. The roller-type linear sliding block as claimed in claim 1, wherein the inner circulation member has an inner track groove of the first circulation track.

6. The roller-type linear sliding block as claimed in claim 5, wherein the middle spacer has an outer track groove of the first circulation track at one side thereof facing the inner circulation member.

7. The roller-type linear sliding block as claimed in claim 1, wherein the middle spacer has an inner track groove of the second circulation track at another side thereof facing the outer circulation member.

8. The roller-type linear sliding block as claimed in claim 7, wherein the outer circulation member has an outer track groove of the second circulation track at one side thereof facing the middle spacer.

9. The roller-type linear sliding block as claimed in claim 1, wherein the outer circulation member is formed with an oil scraper corresponding to the linear sliding rail.
